(19) United States
(12) Patent Application Publication
(10) Pub. No.: US 2014/0359447 A1
(43) Pub. Date: Dec. 4, 2014

(54) Method, Apparatus and Computer Program Product for Generation of Motion Images

(71) Applicant: Nokia Corporation, Espoo (FI)

(72) Inventors: Rajeswari Kannan, Bangalore (IN); Basavaraja S V, Bangalore (IN); Prabuddha Vyas, Bangalore (IN)

(73) Assignee: Nokia Corporation, Espoo (FI)

(21) Appl. No.: 14/372,058

(22) PCT Filed: Jan. 8, 2013
(86) PCT No.: PCT/FI2013/050013

§ 371 Date: Jul. 14, 2014

(30) Foreign Application Priority Data
Jan. 31, 2012 (IN) 365/CHE/2012

(51) Int. Cl. G06F 3/0485; G06F 3/0484

(52) U.S. Cl. CPC G06F 3/04855; G06F 3/04842
USPC 715/720

(57) ABSTRACT

In accordance with an example embodiment a method, apparatus and computer program product are provided. The method comprises facilitating selection of at least one frame from a plurality of frames of a multimedia content. At least one mobile portion associated with the multimedia content is generated based on the selection of the at least one frame. The adjustment of motion of the at least one mobile portion is facilitated. A motion image is generated based on the adjusted motion of the at least one mobile portion.

### TECHNICAL FIELD

Various implementations relate generally to method, apparatus, and computer program product for generation of motion images from multimedia content.

### BACKGROUND

In recent years, various techniques have been developed for digitization and further processing of multimedia content. Examples of multimedia content may include, but are not limited to a video of a movie, a video shot, and the like. The digitization of the multimedia content facilitates in complex manipulation of the multimedia content for enhancing user experience with the digitized multimedia content. For example, the multimedia content may be manipulated and processed for generating motion images that may be utilized in a wide variety of applications. Motion images include a series of images encapsulated within an image file. The series of images may be displayed in a sequence, thereby creating an illusion of movement of objects in the motion image.

### SUMMARY OF SOME EMBODIMENTS

Various aspects of examples embodiments are set out in the claims.

In a first aspect, there is provided a method comprising: facilitating selection of at least one frame from a plurality of frames of a multimedia content; generating at least one mobile portion associated with the multimedia content based on the selection of the at least one frame; facilitating adjustment of motion of the at least one mobile portion; and generating a motion image based on the adjusted motion of the at least one mobile portion.

In a second aspect, there is provided an apparatus comprising at least one processor; and at least one memory comprising computer program code, the at least one memory and the computer program code configured to, with the at least one processor, cause the apparatus to perform at least: facilitating selection of at least one frame from a plurality of frames of a multimedia content; generating at least one mobile portion associated with the multimedia content based on the selection of the at least one frame; facilitating adjustment of motion of the at least one mobile portion; and generating a motion image based on the adjusted motion of the at least one mobile portion.

In a third aspect, there is provided a computer program product comprising at least one computer-readable storage medium, the computer-readable storage medium comprising a set of instructions, which, when executed by one or more processors, cause an apparatus to perform at least: facilitating selection of at least one frame from a plurality of frames of a multimedia content; generating at least one mobile portion associated with the multimedia content based on the selection of the at least one frame; facilitating adjustment of motion of the at least one mobile portion; and generating a motion image based on the adjusted motion of the at least one mobile portion.

In a fourth aspect, there is provided an apparatus comprising: means for facilitating selection of at least one frame from a plurality of frames of a multimedia content; means for generating at least one mobile portion associated with the multimedia content based on the selection of the at least one frame; means for facilitating adjustment of motion of the at least one mobile portion; and means for generating a motion image based on the adjusted motion of the at least one mobile portion.

In a fifth aspect, there is provided a computer program comprising program instructions which when executed by an apparatus, cause the apparatus to: facilitate selection of at least one frame from a plurality of frames of a multimedia content; generate at least one mobile portion associated with the multimedia content based on the selection of the at least one frame; facilitate adjustment of motion of the at least one mobile portion; and generate a motion image based on the adjusted motion of the at least one mobile portion.

### BRIEF DESCRIPTION OF THE FIGURES

Various embodiments are illustrated by way of example, and not by way of limitation, in the figures of the accompanying drawings in which:

FIG. 1 illustrates a device in accordance with an example embodiment;

FIG. 2 illustrates an apparatus for generating motion image from multimedia content in accordance with an example embodiment;

FIG. 3 illustrates a motion adjustment technique for adjusting the motion of mobile portions in a motion image in accordance with an example embodiment;

FIG. 4 illustrates an exemplary user interface (UI) for adjusting the motion of mobile portions in a motion image in accordance with an example embodiment;

FIGS. 5A and 5B illustrate exemplary UIs for generating motion image associated with multimedia content in an apparatus in accordance with example embodiments;

FIGS. 6A, 6B, 6C and 6D illustrate various exemplary UIs for performing selection for generating motion images in accordance with various example embodiments;

FIG. 7 is a flowchart depicting an example method for generating motion image associated with multimedia content in accordance with an example embodiment; and

FIGS. 8A and 8B illustrate a flowchart depicting an example method for generating motion image associated with multimedia content in accordance with another example embodiment.

### DETAILED DESCRIPTION

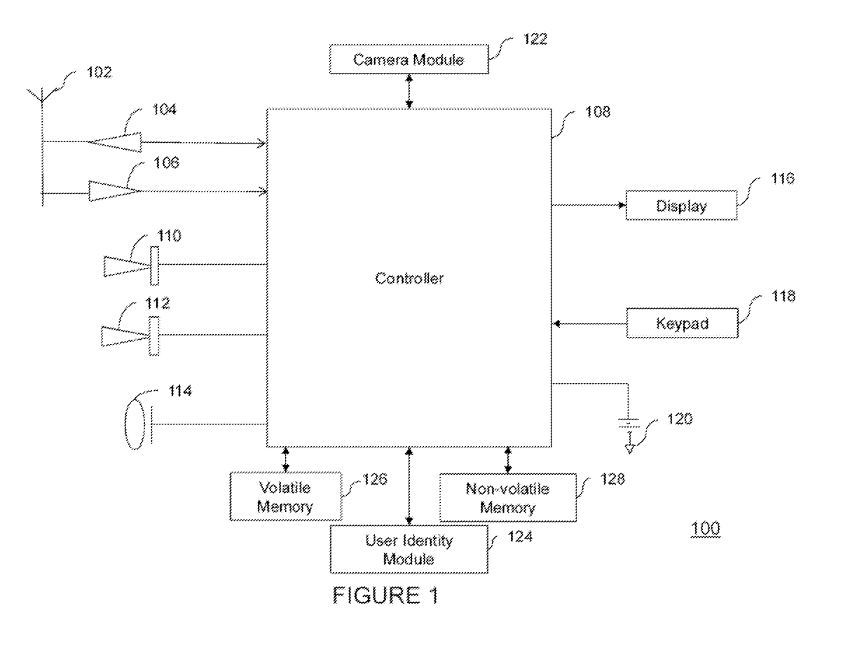

Example embodiments and their potential effects are understood by referring to FIGS. 1 through 8B of the drawings.

FIG. 1 illustrates a device 100 in accordance with an example embodiment. It should be understood, however, that the device 100 as illustrated and hereinafter described is merely illustrative of one type of device that may benefit from various embodiments, therefore, should not be taken to limit the scope of the embodiments. As such, it should be appreciated that at least some of the components described below in connection with the device 100 may be optional and thus in an example embodiment may include more, less or different components than those described in connection with the example embodiment of FIG. 1. The device 100 could be any of a number of types of mobile electronic devices, for example, portable digital assistants (PDAs), pagers, mobile televisions, gaming devices, cellular phones, all types of computers (for example, laptops, mobile computers or desktops), cameras, audio/video players, radios, global positioning system (GPS) devices, media players, mobile digital assistants, or any combination of the aforementioned, and other types of communications devices.

The device 100 may include an antenna 102 (or multiple antennas) in operable communication with a transmitter 104 and a receiver 106. The device 100 may further include an apparatus, such as a controller 108 or other processing device that provides signals to and receives signals from the transmitter 104 and receiver 106, respectively. The signals may include signaling information in accordance with the air interface standard of the applicable cellular system, and/or may also include data corresponding to user speech, received data and/or user generated data. In this regard, the device 100 may be capable of operating with one or more air interface standards, communication protocols, modulation types, and access types. By way of illustration, the device 100 may be capable of operating in accordance with any of a number of first, second, third and/or fourth-generation communication protocols or the like. For example, the device 100 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA1000, wideband CDMA (WCDMA) and time division-synchronous CDMA (TD-SCDMA), with 3.9G wireless communication protocol such as evolved-universal terrestrial radio access network (E-UTRAN), with fourth-generation (4G) wireless communication protocols, or the like. As an alternative (or additionally), the device 100 may be capable of operating in accordance with non-cellular communication mechanisms. For example, computer networks such as the Internet, local area network, wide area networks, and the like; short range wireless communication networks such as include Bluetooth® networks, Zigbee® networks, Institute of Electric and Electronic Engineers (IEEE) 802.11x networks, and the like; wireline telecommunication networks such as public switched telephone network (PSTN).

The controller 108 may include circuitry implementing, among others, audio and logic functions of the device 100. For example, the controller 108 may include, but are not limited to, one or more digital signal processor devices, one or more microprocessor devices, one or more processor(s) with accompanying digital signal processor(s), one or more processor(s) without accompanying digital signal processor(s), one or more special-purpose computer chips, one or more field-programmable gate arrays (FPGAs), one or more controllers, one or more application-specific integrated circuits (ASICs), one or more computer(s), various analog to digital converters, digital to analog converters, and/or other support circuits. Control and signal processing functions of the device 100 are allocated between these devices according to their respective capabilities. The controller 108 thus may also include the functionality to convolutionally encode and interleave message and data prior to modulation and transmission. The controller 108 may additionally include an internal voice coder, and may include an internal data modem. Further, the controller 108 may include functionality to operate one or more software programs, which may be stored in a memory. For example, the controller 108 may be capable of operating a connectivity program, such as a conventional Web browser. The connectivity program may then allow the device 100 to transmit and receive Web content, such as location-based content and/or other web page content, according to a Wireless Application Protocol (WAP), Hypertext Transfer Protocol (HTTP) and/or the like. In an example embodiment, the controller 108 may be embodied as a multi-core processor such as a dual or quad core processor. However, any number of processors may be included in the controller 108.

The device 100 may also comprise a user interface including an output device such as a ringer 110, an earphone or speaker 112, a microphone 114, a display 116, and a user input interface, which may be coupled to the controller 108. The user input interface, which allows the device 100 to receive data, may include any of a number of devices allowing the device 100 to receive data, such as a keypad 118, a touch display, a microphone or other input device. In embodiments including the keypad 118, the keypad 118 may include numeric (0-9) and related keys (#, *), and other hard and soft keys used for operating the device 100. Alternatively or additionally, the keypad 118 may include a conventional QWERTY keypad arrangement. The keypad 118 may also include various soft keys with associated functions. In addition, or alternatively, the device 100 may include an interface device such as a joystick or other user input interface. The device 100 further includes a battery 120, such as a vibrating battery pack, for powering various circuits that are used to operate the device 100, as well as optionally providing mechanical vibration as a detectable output.

In an example embodiment, the device 100 includes a media capturing element, such as a camera, video and/or audio module, in communication with the controller 108. The media capturing element may be any means for capturing an image, video and/or audio for storage, display or transmission. In an example embodiment in which the media capturing element is a camera module 122, the camera module 122 may include a digital camera capable of forming a digital image file from a captured image. As such, the camera module 122 includes all hardware, such as a lens or other optical component(s), and software for creating a digital image file from a captured image. Alternatively, the camera module 122 may include the hardware needed to view an image, while a memory device of the device 100 stores instructions for execution by the controller 108 in the form of software to create a digital image file from a captured image. In an example embodiment, the camera module 122 may further include a processing element such as a co-processor, which assists the controller 108 in processing image data and an encoder and/or decoder for compressing and/or decompressing image data. The encoder and/or decoder may encode and/or decode according to a JPEG standard format or another like format. For video, the encoder and/or decoder may employ any of a plurality of standard formats such as, for example, standards associated with H.261, H.262/MPEG-2, H.263, H.264, H.264/MPEG-4, MPEG-4, and the like. In some cases, the camera module 122 may provide live image data to the display 116. Moreover, in an example embodiment, the display 116 may be located on one side of the device 100 and the camera module 122 may include a lens positioned on the opposite side of the device 100 with respect to the display 116 to enable the camera module 122 to capture images on one side of the device 100 and present a view of such images to the user positioned on the other side of the device 100.

The device 100 may further include a user identity module (UIM) 124. The UIM 124 may be a memory device having a processor built in. The UIM 124 may include, for example, a subscriber identity module (SIM), a universal integrated circuit card (UICC), a universal subscriber identity module (USIM), a removable user identity module (R-UIM), or any other smart card. The UIM 124 typically stores information elements related to a mobile subscriber. In addition to the UIM 124, the device 100 may be equipped with memory. For example, the device 100 may include volatile memory 126, such as volatile random access memory (RAM) including a cache area for the temporary storage of data. The device 100 may also include other non-volatile memory 128, which may be embedded and/or may be removable. The non-volatile memory 128 may additionally or alternatively comprise an electrically erasable programmable read only memory (EEPROM), flash memory, hard drive, or the like. The memories may store any number of pieces of information, and data, used by the device 100 to implement the functions of the device 100.

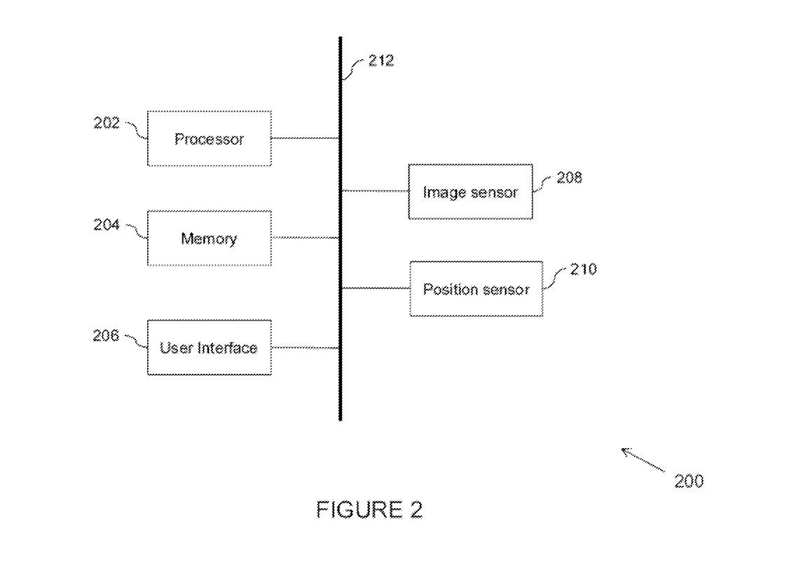

FIG. 2 illustrates an apparatus 200 for generating motion images associated with multimedia content, in accordance with an example embodiment. In an embodiment, the multimedia content is a video recording of an event, for example, a birthday party, a cultural event celebration, a game event, and the like. In an embodiment, the multimedia content may be captured by a media capturing device, for example, the device 100. Examples of the multimedia capturing device may include, but are not limited to, a camera, a mobile phone having multimedia capturing functionalities, and the like. In an embodiment, the multimedia content may be captured by using 3-D cameras, 2-D cameras, and the like.

The apparatus 200 may be employed for generating the motion image associated with the multimedia content, for example, in the device 100 of FIG. 1. However, it should be noted that the apparatus 200, may also be employed on a variety of other devices both mobile and fixed, and therefore, embodiments should not be limited to application on devices such as the device 100 of FIG. 1. Alternatively, embodiments may be employed on a combination of devices including, for example, those listed above. Accordingly, various embodiments may be embodied wholly at a single device, (for example, the device 100 or in a combination of devices. Furthermore, it should be noted that the devices or elements described below may not be mandatory and thus some may be omitted in certain embodiments.

The apparatus 200 includes or otherwise is in communication with at least one processor 202 and at least one memory 204. Examples of the at least one memory 204 include, but are not limited to, volatile and/or non-volatile memories. Some examples of the volatile memory includes, but are not limited to, random access memory, dynamic random access memory, static random access memory, and the like. Some example of the non-volatile memory includes, but are not limited to, hard disks, magnetic tapes, optical disks, programmable read only memory, erasable programmable read only memory, electrically erasable programmable read only memory, flash memory, and the like. The memory 204 may be configured to store information, data, applications, instructions or the like for enabling the apparatus 200 to carry out various functions in accordance with various example embodiments. For example, the memory 204 may be configured to buffer input data comprising media content for processing by the processor 202. Additionally or alternatively, the memory 204 may be configured to store instructions for execution by the processor 202.

An example of the processor 202 may include the controller 108. The processor 202 may be embodied in a number of different ways. The processor 202 may be embodied as a multi-core processor, a single core processor; or combination of multi-core processors and single core processors. For example, the processor 202 may be embodied as one or more of various processing means such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the multi-core processor may be configured to execute instructions stored in the memory 204 or otherwise accessible to the processor 202. Alternatively or additionally, the processor 202 may be configured to execute hard coded functionality. As such, whether configured by hardware or software methods, or by a combination thereof, the processor 202 may represent an entity, for example, physically embodied in circuitry, capable of performing operations according to various embodiments while configured accordingly. For example, if the processor 202 is embodied as two or more of an ASIC, FPGA or the like, the processor 202 may be specifically configured hardware for conducting the operations described herein. Alternatively, as another example, if the processor 202 is embodied as an executor of software instructions, the instructions may specifically configure the processor 202 to perform the algorithms and/or operations described herein when the instructions are executed. However, in some cases, the processor 202 may be a processor of a specific device, for example, a mobile terminal or network device adapted for employing embodiments by further configuration of the processor 202 by instructions for performing the algorithms and/or operations described herein. The processor 202 may include, among other things, a clock, an arithmetic logic unit (ALU) and logic gates configured to support operation of the processor 202.

A user interface 206 may be in communication with the processor 202. Examples of the user interface 206 include, but are not limited to, input interface and/or output user interface. The input interface is configured to receive an indication of a user input. The output user interface provides an audible, visual, mechanical or other output and/or feedback to the user. Examples of the input interface may include, but are not limited to, a keyboard, a mouse, a joystick, a keypad, a touch screen, soft keys, and the like. Examples of the output interface may include, but are not limited to, a display such as light emitting diode display, thin-film transistor (TFT) display, liquid crystal displays, active-matrix organic light-emitting diode (AMOLED) display, a microphone, a speaker, ringers, vibrators, and the like. In an example embodiment, the user interface 206 may include, among other devices or elements, any or all of a speaker, a microphone, a display, and a keyboard, touch screen, or the like. In this regard, for example, the processor 202 may comprise user interface circuitry configured to control at least some functions of one or more elements of the user interface 206, such as, for example, a speaker, ringer, microphone, display, and/or the like. The processor 202 and/or user interface circuitry comprising the processor 202 may be configured to control one or more functions of one or more elements of the user interface 206 through computer program instructions, for example, software and/or firmware, stored on a memory, for example, the at least one memory 204, and/or the like, accessible to the processor 202.

In an example embodiment, the apparatus 200 may include an electronic device. Some examples of the electronic device include communication device, media capturing device with communication capabilities, computing devices, and the like. Some examples of the communication device may include a mobile phone, a personal digital assistant (PDA), and the like. Some examples of computing device may include a laptop, a personal computer, and the like. In an example embodiment, the communication device may include a user interface, for example, the UI 206, having user interface circuitry and user interface software configured to facilitate a user to control at least one function of the communication device through use of a display and further configured to respond to user inputs. In an example embodiment, the communication device may include a display circuitry configured to display at least a portion of the user interface of the communication device. The display and display circuitry may be configured to facilitate the user to control at least one function of the communication device.

In an example embodiment, the communication device may be embodied as to include a transceiver. The transceiver may be any device operating or circuitry operating in accordance with software or otherwise embodied in hardware or a combination of hardware and software. For example, the processor 202 operating under software control, or the processor 202 embodied as an ASIC or FPGA specifically configured to perform the operations described herein, or a combination thereof, thereby configures the apparatus or circuitry to perform the functions of the transceiver. The transceiver may be configured to receive media content. Examples of media content may include audio content, video content, data, and a combination thereof.

In an example embodiment, the communication device may be embodied as to include an image sensor, such as an image sensor 208. The image sensor 208 may be in communication with the processor 202 and/or other components of the apparatus 200. The image sensor 208 may be in communication with other imaging circuitries and/or software, and is configured to capture digital images or to make a video or other graphic media files. The image sensor 208 and other circuitries, in combination, may be an example of the camera module 122 of the device 100.

In an example embodiment, the communication device may be embodied as to include an inertial/position sensor 210. The inertial/sensor 210 may be in communication with the processor 202 and/or other components of the apparatus 200. The inertial/positional sensor 210 may be in communication with other imaging circuitries and/or software, and is configured to track movement/navigation of the apparatus 200 from one position to another position.

These components (202-210) may communicate to each other via a centralized circuit system 212 to perform capturing of 3-D image of a scene associated with the multimedia content. The centralized circuit system 212 may be various devices configured to, among other things, provide or enable communication between the components (202-210) of the apparatus 200. In certain embodiments, the centralized circuit system 212 may be a central printed circuit board (PCB) such as a motherboard, main board, system board, or logic board. The centralized circuit system 312 may also, or alternatively, include other printed circuit assemblies (PCAs) or communication channel media.

In an example embodiment, the processor 202 is configured to, with the content of the memory 204, and optionally with other components described herein, to cause the apparatus 200 to generate a motion image associated with the multimedia content. In an embodiment, the multimedia content may include a video content. The motion image comprises at least one mobile portion and a set of still portions. The mobile portion of the motion image may include a series of images (or frames) encapsulated within an image file. The series of images may be displayed in a sequence, thereby creating an illusion of movement of objects in the motion image.

In an embodiment, the multimedia content may be prerecorded and stored in the apparatus, for example the apparatus 200. In another embodiment, the multimedia content may be captured by utilizing the device, and stored in the memory of the device. In yet another embodiment, the device 100 may receive the multimedia content from internal memory such as hard drive, random access memory (RAM) of the apparatus 200, or from external storage medium such as DVD, Compact Disk (CD), flash drive, memory card, or from external storage locations through Internet, Bluetooth®, and the like. The apparatus 200 may also receive the multimedia content from the memory 204.

In an example embodiment, the processor 202 is configured to, with the content of the memory 204, and optionally with other components described herein, to cause the apparatus 200 to capture the multimedia content for generating the motion image from the multimedia content. In an embodiment, the multimedia content may be captured by displacing the apparatus 200 in at least one direction. For example, the apparatus 200 such as a camera may be moved around the scene either from left direction to right direction, or from right direction to left direction, or from top direction to a bottom direction, or from bottom direction to top direction, and so on. In some embodiments, the apparatus 200 may be configured to determine a direction of movement at least in parts and under some circumstances automatically, and provide guidance to a user to move the apparatus 200 in the determined direction. In an embodiment, the apparatus 200 may be an example of a media capturing device, for example, a camera. In some embodiments, the apparatus 200 may include a position sensor, for example the position sensor 210 for guiding movement of the apparatus 200 to determine direction of movement of the apparatus for capturing the multimedia content. In an embodiment, the multimedia content may be a movie recording of an event, for example an entertainment movie, a football game, a movie of a birthday party, or any other movie recording of a substantial length.

In an embodiment, the multimedia content, for example videos, in a raw form (for example, when captured by multimedia capturing device) may consist of unstructured video streams having a sequence of video shots that may not all be interest to the user. Each video shot is composed of a number of media frames such that the content of the video shot may be represented by key-frames only. Such key frames containing thumbnails, images, and the like, may be extracted from the video shot to summarize the multimedia content. As disclosed herein, the collection of the key frames associated with a multimedia content is defined as summarization. In general, the key-frames may act as the representative frames of the video shot for video indexing, surfing, and recovery.

In an embodiment, the processor 202 is configured to, with the content of the memory 204, and optionally with other components described herein, to cause the apparatus 200 to perform summarization of the multimedia content for generating a plurality of summarized multimedia segments. In an embodiment, the summarization of the multimedia content may be performed while capturing the multimedia content. In an embodiment, the summarization of multimedia content may be performed at least in parts or under certain circumstances automatically and/or without or minimal user interaction. In an example embodiment, the summarization may involve extracting segment boundaries and key frames (such as iframes) while capturing the multimedia content. Various frame features may be utilized for segmentation and key frame extraction for the purpose of summarizing the multimedia content. Various other techniques may be utilized for summarization of the multimedia content while capturing. For example, in some embodiments, the summarization of the multimedia content may be performed at least in parts or under certain circumstances automatically by applying time based algorithms that may detect various scenes of the multimedia content, and show only scenes of significant interest. For example, based on user preference and/or past experiences, the algorithm may detect scenes with certain ‘face portions’ and show only those scenes having the ‘face portions’ in the summarized multimedia content. In an example embodiment, a processing means may be configured to perform the summarization of the multimedia content. An example of the processing means may include the processor 202, which may be an example of the controller 108.

In various embodiments, the multimedia content may be summarized to generate a plurality of frames. For example, for a summarized multimedia content of a video of a football match may include plurality of frames various interesting events of the football game, such as goal making scenes, a superb catch, some funny audience moments, cheering cheerleaders, and the like. In an example embodiment, the processor 202 is configured to, with the content of the memory 204, and optionally with other components described herein, to cause the apparatus 200 to facilitate selection of at least one frame of the plurality of frames of the multimedia content. In an example embodiment, a processing means may be configured to facilitate selection of at least one frame of the plurality of frames. An example of the processing means may include the processor 202, which may be an example of the controller 108.

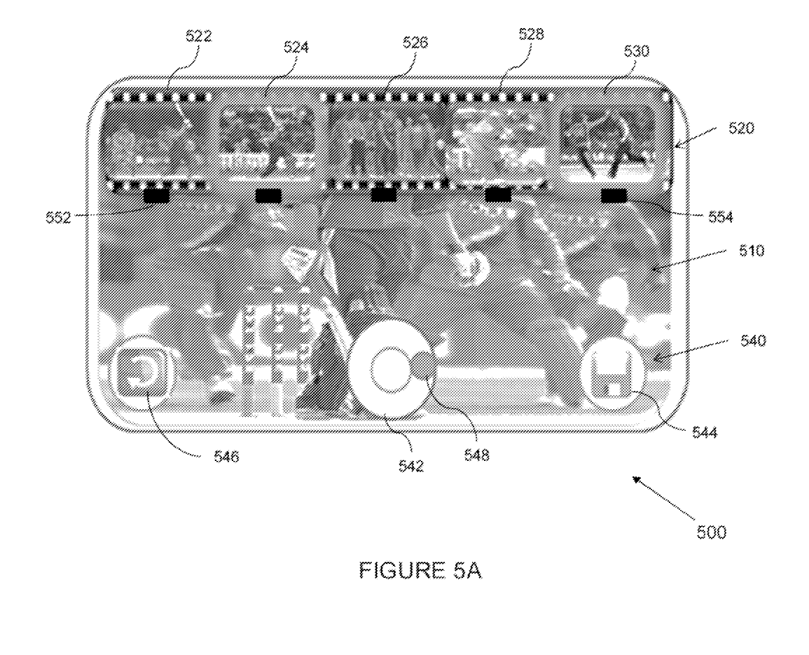

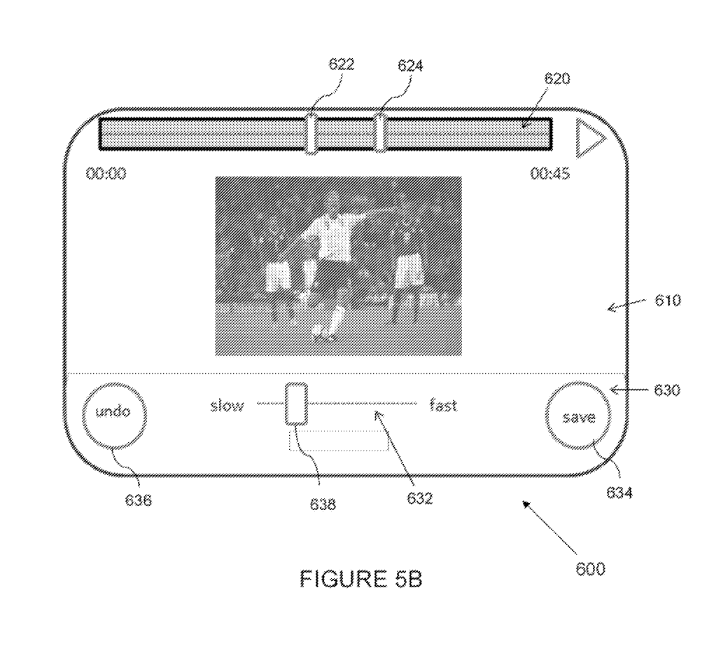

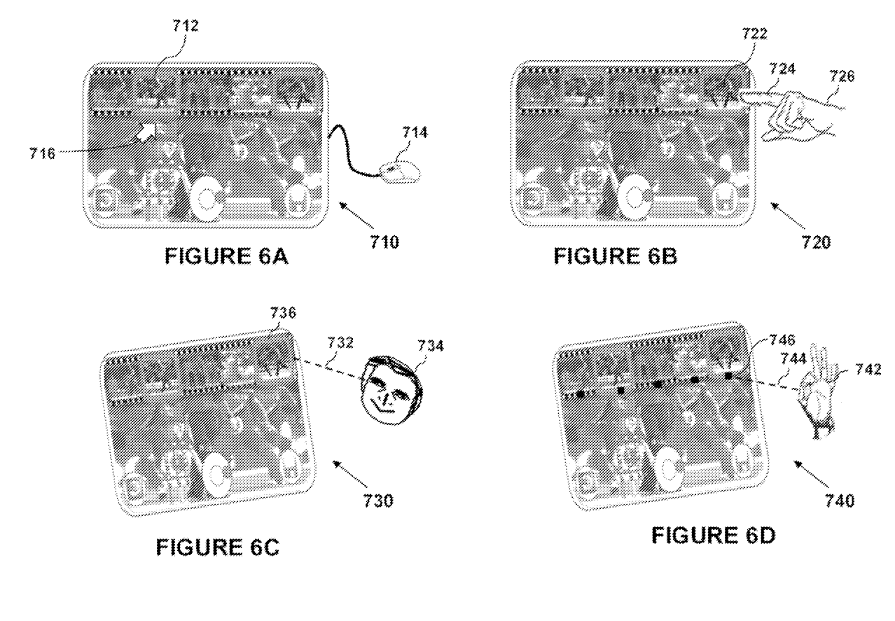

In an embodiment, the plurality of frames associated with the plurality of summarized multimedia segments may be made available for the selection by means of a user interface (UI), such as the UI 206. In various embodiments, the user may be enable to select the summarized multimedia content. In an embodiment, the processor 202 is configured to, with the content of the memory 204, and optionally with other components described herein, to cause the apparatus 200 to facilitate selection of at least one frame from the plurality of frames. In an embodiment, the selection may be facilitated based on user preferences. For example, the user may choose a frame comprising a face portion of a subject; a frame comprising a particular brand of furniture; various summarized multimedia scenes containing a goal, wickets and other such interesting events of a game; or various summarized multimedia content or scene containing interesting events of a party or family gathering, and the like. The UI for selection of the at least one summarized multimedia content is discussed in detail with reference to FIGS. 5A to 6D.

In an embodiment, the user interface 206 facilitates the user to select the at least one frame based on a user action. In an embodiment, the user action may include a mouse click, a touch on a display of the user interface, a gaze of the user, any other gesture made by the user, and the like. In an embodiment, the selected at least one frame may appear highlighted on the UI. In an example embodiment, the selected at least one frame may appear highlighted in a color, for example, red color. The UI for displaying selected at least one frame, and various options for facilitating the selection are described in detail in conjunction with FIGS. 6A to 6D.

In an embodiment, the processor 202 is configured to, with the content of the memory 204, and optionally with other components described herein, to cause the apparatus 200 to generate at least one mobile portion associated with the multimedia content based on the selection of the at least one frame. In an embodiment, the mobile portion comprises a sequence of images depicting a motion presented in a scene of the multimedia content. For example, the multimedia content may be a video scene of a birthday party, and the mobile portion may comprise a cake-cutting scene of the birthday party. In an example embodiment, a processing means may be configured to generate at least one mobile portion associated with the multimedia content. An example of the processing means may include the processor 202, which may be an example of the controller 108.

In various embodiments, the at least one mobile portion comprises the at least one frame that is selected from the plurality of frames. In various embodiments, the selected at least one frame is indicative of beginning of the mobile portion. For example, in a multimedia content comprising a video of a football match, a mobile portion associated with a goal-making scene may include the at least one frame as the starting frame of mobile portion, wherein the at least one frame comprises a thumbnail showing a player hitting a football with his feet.

In some embodiments, the at least one frame may also include a last frame or an end frame of the mobile portion. In some embodiments, the processor 202 is configured to, with the content of the memory 204, and optionally with other components described herein, to cause the apparatus 200 to facilitate selection of the end frame of the mobile portion by the user. In some embodiments, the user may select the end frame by utilizing a UI such as the UI 206. In an example embodiment, the UI for selecting the end frame is explained in detail with reference to FIGS. 5A to 6D.

In some alternative embodiments, the end frames may be selected at least one in parts or under certain circumstance automatically without or with a minimal user intervention. For example, upon selection of the starting frame or the beginning frame of a scene, a significant change of the scene may be observed, and the end frame may be selected as one of the last frames of the scene. In an embodiment, if the user selects a frame next to the last frame of the scene as the end frame of the mobile portion, then the selection by the user may be deemed invalid or incorrect. In this embodiment, the last frame of the mobile portion may be selected at least in parts and under certain circumstances, automatically, as the end frame of the motion image.

In an embodiment, the selected end frame of the mobile portion may be displayed as highlighted on the UI in a distinct color, for example, red color. In various embodiments, the distinct color of the start frame and the end frame associated with a respective mobile portion of the motion image may facilitate a user to identify the frames and the contents of the mobile portion of the motion image.

In an embodiment, the processor 202 is configured to, with the content of the memory 204, and optionally with other components described herein, to cause the apparatus 200 to select the stationary or the still portions of the motion image. In an embodiment, the processor 202, with the content of the memory 204, and optionally with other components and algorithms described herein may select the iframes and the representative frames at least in parts or under certain circumstances automatically as the stationary frames. In various embodiments, two similar looking frames may not be selected for configuring the still portions of the motion image. For example, the adjacent frames having minimal or nil difference may not be selected for the still portions of the motion image. In an example embodiment, a processing means may be configured to select the stationary or the still portions of the motion image. An example of the processing means may include the processor 202, which may be an example of the controller 108.

In some embodiments, the still portions of the motion image may be selected while capturing the multimedia content. For example, during the multimedia capture the processor 202 along with the content of the memory 204, and optionally with other components described herein, may cause the apparatus 200 to capture the frames associated with the still portions (herein after referred to as still frames) at least in parts or under certain circumstances automatically. In some embodiments, depending on one or more of bandwidth, quality, and screen size of the motion image, the resolution of the frames associated with still portion may be determined dynamically. For example, in case a low-resolution motion image is desired, the captured frames may be inserted in-between various frames of the mobile portion at regular intervals. As another example, in case a high-resolution motion image is desired then all the still portions may be high-resolution image frames, for example, 8-megapixel frame, thereby enabling better zooming in the motion image. For example, a bird flying at a far-off distance also may be shown in a very detailed way in a high-resolution motion image. In an embodiment, selecting more number of frames associated with the still portions may render the motion image appear natural. The selection of frames for the still portions and the mobile portions of the mobile image is explained in more detail in FIGS. 6A and 6D.

In an embodiment, the processor 202 is configured to, with the content of the memory 204, and optionally with other components described herein, to cause the apparatus 200 to receive an input for adjusting motion of the at least one mobile portion. In an embodiment, the apparatus is configured to receive the input by means of a UI, such as the UI 206. In some embodiments, adjusting the motion of the mobile portion comprises performing at least one of adjusting a level of speed of motion, a sequence of occurrence of the mobile portion, and a timeline indicative of occurrence of the at least one mobile portion in a motion image. In an embodiment, the motion of more than one mobile portions may be adjusted based on the selection of more than one starting frames. For example, a first mobile portion may be selected and motion of the first mobile portion may be adjusted to be faster than that of a second mobile portion associated with the motion image. In an embodiment, the level of speed of the motion of the mobile portion may vary from very high, a high speed, a medium speed, a low speed, a very low speed, a nil speed and the like.

In an embodiment, the motion information of the mobile portions may be stored in a memory, for example, the memory 204. In an embodiment, the processor 202 is configured to, with the content of the memory 204, and optionally with other components described herein, to cause the apparatus 200 to facilitate storing of an information associated with the motion of the mobile portions. In various embodiments, the information may be stored in a memory, for example, the memory 204. In some embodiments, the stored information associated with the motion of the mobile portions may be altered. In an embodiment, the motion information may be altered based on user-preferences. In an alternate embodiment, the motion information may be altered at least in parts and under certain circumstances automatically.

In an embodiment, the processor 202 is configured to, with the content of the memory 204, and optionally with other components described herein, to cause the apparatus 200 to generate a motion image based on the adjusted motion of the at least one mobile portion. In some embodiments, the motion image is generated based on the at least one mobile portion and the set of still portions associated with the multimedia content. The generation of the motion image from the at least one mobile portion and the set of still portions is explained in detail in FIG. 4.

In an embodiment, the motion image may be stored in a memory, for example, the memory 204. In an embodiment, the motion image may be stored in a graphics interchange format (GIF). The GIF format allows easy sharing of motion image with user because of low memory requirement. In alternative embodiments, for storing a high-resolution motion image, such as super-resolution image or higher megapixel images, various other formats such as audio video interleave (AVI) format, and Hypertext markup language (HTML) 5 may be utilized for storing the motion image.

In an embodiment, the processor 202 is configured to, with the content of the memory 204, and optionally with other components described herein, to cause the apparatus 200 to display the motion image. In an embodiment, the motion image may be displayed by means of a UI, for example the UI 206. In an embodiment, the user action may include a mouse click, a touch on a display of the user interface, a gaze of the user, and the like. In an embodiment, the starting frame and the end frame may appear highlighted on the user interface. The user interface for displaying the starting frame and end frame, and various options for facilitating the selection of frames and/or options are described in detail in conjunction with FIGS. 5A to 6D.

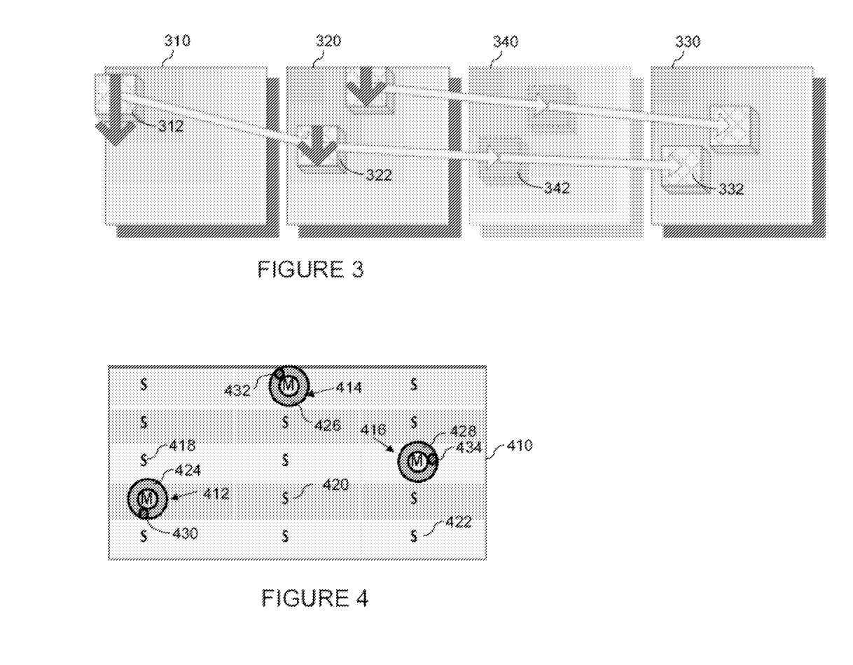

In an embodiment, the processor 202 is configured to, with the content of the memory 204, and optionally with other components described herein, to cause the apparatus 200 to generate the motion image at least in parts and under some circumstances automatically. In some example embodiments, the motion image may be generated based on object detection. For example, when a face portion is detected in a multimedia content, the face portion may at least in parts and under some circumstances automatically be selected as the at least one frame of the mobile portion, and the mobile portion may be generated based on the selected face portion. It will be understood various embodiments for the automatic generation of the mobile images are possible without departing from the spirit and scope of the technology. Various embodiments of generating motion images from multimedia content are further described in FIGS. 3 to 8B.

FIG. 3 illustrates a motion adjustment technique for adjusting the motion of mobile portions in a motion image in accordance with an example embodiment. In various embodiments, the speed of motion of the mobile portions of a motion image may be adjusted to any level varying from a very high speed to a very slow speed. In an embodiment, for adjusting the motion of the mobile portion to a slow speed, the mobile portion of the motion image may be played at a lower speed than that at which the multimedia content is recorded.

In an alternate embodiment, the speed of the mobile portion may be reduced by inserting new frames in-between the frames of mobile portion to generate a modified mobile portion, and then playing modified mobile portion at a normal speed. For example, as illustrated in FIG. 3, frames 310, 320 and 330 may be extracted from a mobile portion. In order to reduce the speed of motion of the mobile portion, new frames, such as a frame 340 may be inserted between two original frames, such as frames 320 and 330, to generate a modified mobile portion. In another embodiment, the new frames (such as the frame 340) may be reproduced by interpolating between the two existing frames, for example the frames 320 and the frame 330.

In some embodiments, motion interpolation techniques may be utilized for determining a motion vector (MV) field of interpolated frames, and generating the intermediate frames, such as the frame 340, so that the generated motion image may appear natural and smooth. As illustrated in FIG. 3, motion of an object in three subsequent frames 310, 320, 330 is illustrated as 312, 322 and 332 respectively. If a new or additional frame, for example the frame 340 is inserted between the two existing frames 320 and 230, then the motion of the object in the new frame 340 may be illustrated as marked by 342. In an alternative embodiment, the new frames (such as the frame 340) comprise a repetition of a previous frame, for example, the frame 320, instead of interpolating the previous frame.

In an embodiment, the motion of the mobile portion may be made faster than the motion associated with the original speed of motion by playing the generated mobile portion at a faster speed than the original speed of the mobile portion. In another embodiment, the frames occurring between two frames may be deleted to generate a modified mobile portion and the modified mobile portion may be played at a normal speed. For example, as illustrated in FIG. 3, assuming that the original multimedia portion includes the frames 310, 320 and 330, and it is desired to increase the speed of the mobile portion, then the frame 320 may be deleted from the sequence of frames such that only the frames 310 and 330 are remaining in the modified mobile portion. The modified mobile portion comprising frames 310 and 330 may be played for playing the mobile portion at a higher speed.

FIG. 4 illustrates an exemplary UI 400 for the motion of mobile portions in a motion image 410 in accordance with an example embodiment. In an embodiment, FIG. 4 illustrates an exemplary representation of arrangement of mobile portions and still portions of a motion image 410, a technique of adjusting a speed of motion of the mobile portions. The motion image 410 may include at least one mobile portion and a set of still portions. For example, when the multimedia content is a video of a birthday party, the at least one mobile portion may include a cake cutting event, a dance performance, an orchestra performance, a magic show event, and the like which may be part of the birthday party. Examples of the still portions of the motion image may include still background illustrating the guests while the cake is being cut, a still piano while the orchestra is being played, and the like.

As illustrated in FIG. 3A, various mobile portions of the motion image 410 may be marked as ‘M’ while various still portions may be marked as ‘S’ for the purpose of distinction. For example, the mobile portions ‘M’ are numbered as 412, 414, 416, while few of the still portions are numbered as 418, 420, 422, and the like. It will be understood that all the still portions ‘S’ are not numbered in the motion image 410 for the sake of clarity of description. In an embodiment, the number of the mobile portions in the motion image may be lesser than the number of still portions. In an embodiment, a lesser number of a motion portions in the motion image facilitates in enhancing the aesthetics of the motion image.

In an example embodiment, various mobile portions ‘M’ and the still portions ‘S’ may be illustrated by utilizing a UI. In an embodiment, the motion of the mobile portions may be adjusted by utilizing the UI. For example, as illustrated in FIG. 4 in an exemplary UI, the mobile portions such as mobile portions 412, 414 and 416 may be provided with a scrollable round bar such as a round bar 424, 426, 428 respectively that may appear on the screen of the UI. Each of the scrollable round bars may include a scroll element such as elements 430, 432, and 434, respectively that may be moved in a clockwise direction or an anticlockwise direction for adjusting the speed of the respective mobile portions 412, 414, and 416. In an embodiment, the speed of the mobile portions 412, 414, and 46 in the motion image 410 may be adjusted to be one of very high, high, medium, low, very low and the like. An exemplary technique for adjusting the speed of motion of the mobile portion is explained with reference to FIG. 4.

FIGS. 5A and 5B illustrate exemplary UIs, for example a UI 500 and a UI 600 respectively for generating motion image associated with a multimedia content in accordance with example embodiments. As illustrated in FIG. 5A, the UI 500 may be an example of a user interface 206 of the apparatus 200 or the UI 400 of FIG. 4. In the example embodiment as shown in FIG. 5A, the UI 500 is caused to display a scene area 510, a thumbnail preview area 520 and an option display area 540.

In an example embodiment, the scene area 510 displays a viewfinder of the image capturing and motion image generation application of the apparatus 200. For instance, as the apparatus 200 moves in a direction, the preview of a current scene focused by the camera of the apparatus 200 also changes and is simultaneously displayed in the screen area 510, and the preview displayed on the screen area 510 can be instantaneously captured by the apparatus 200. In another embodiment, the screen area 510 may display a pre-recorded multimedia content of the apparatus 200.

As illustrated In FIG. 5A, the scene/video captured depicts a game of cricket between two teams representing two different countries, for example, India and England. The cricket match is assumed to be of a considerable duration, and the video of the match may be summarized. In an embodiment, the video of the match may be summarized at least in parts or under certain circumstances automatically without or a minimal user intervention. In an embodiment, the video of the match may be summarized while capturing the video by a media capturing device, such as camera. In an embodiment, the summarized multimedia content may include a plurality frames representing a plurality of key events of the match. For example, for a cricket match, the plurality of frames may be associated with wickets, winning moments, a superb catch and some funny audience faces. In an embodiment, such frames may be user frames of interest (UFOIs). Such frames may be shown in the thumbnail preview area 520. For example, the thumbnail preview area may show thumbnail frames such as 522, 524, 526, 528, and 530.

In an embodiment, the at least one frame selected by the user may be a start frame of the mobile portion. In the present embodiment, the end frame of the mobile portion may be selected at least in parts and under certain circumstances automatically. For example, the user may select the frame 524 as the start frame, and the frame 530 may be selected as the end frame at least in parts and under certain circumstances automatically. In an embodiment, the end frame may be selected at least in parts and under certain circumstances automatically based on the determination of a significant scene change. For example, when a significant change of a scene is determined, the associated frame may be considered to be the end frame of the respective mobile portion. In alternate embodiments, the user may select the start frame and the end frame based on a preference. For example, the user may select the frame 524 as the start frame and the frame 528 as the end frame for the generation of a mobile portion of the motion image.

In some embodiments, the user may select frames in a close vicinity as the start frame and the end frame. For example, the user may select the frame 524 as the start frame and the frame 526 as the end frame. Since a scene change may not occur immediately after the beginning of the scene, the selection of the frame 526 as the end frame may be determined to be an error in such a scenario. In such a scenario, the end frame may be determined at least in part and under certain circumstances automatically.

In an embodiment, the frames selected by the user as the starting frame and the end frame of a mobile portion may highlighted in a color. For example, as illustrated in FIG. 5A, the frames 524 and 530 may be selected as the start and the end frames respectively for a mobile portion, and are shown highlighted in a distinct color.

In an example embodiment, the option display area 540 facilitates in provisioning of various options for selection of the at least frame in order to generate a motion image. In the option display area 540, a plurality of options may be displayed. In an embodiment, the plurality of options may be displayed by means of various options tabs such as a motion selection tab 542 for adjusting the speed of motion of the a mobile portion, a save tab 544, and a selection undo tab (shown as ‘undo’) 546.

In an embodiment, the motion selection tab 542 facilitates in selection of the motion of the mobile portion of the motion image. The motion is indicative of a level of speed of motion of the mobile portion in the motion image. In some embodiment, the motion may include at least one of a sequence of occurrence of the respective mobile portion, and a timeline indicative of occurrence of the respective portion in the motion image. As already discussed with reference to FIG. 4, the motion selection tab 542 may include a motion element, such as a motion element 548, for adjusting a level of speed of the selected motion element. In an embodiment, upon operating the motion element 548 in one of a clockwise or anticlockwise direction, the speed of the mobile portion may be adjusted as per the user preferences.

In an embodiment, the selection of one or more options, such as operation of motion selection tab 542 to adjust the speed of a mobile portion to a particular level, may be saved to generate the mobile portion of the motion image. In an embodiment, the selection may be saved by operating the ‘Save’ tab 544 in the options display area 540. For example, upon operating the save tab 544, the mobile portion with the selected speed may be saved.

In an embodiment, when the selection undo tab 546 is selected or operated, the operation of saving the mobile portion with the adjusted speed is reversed. In various embodiments, the selection of the ‘undo’ tab 546 facilitates in reversing the last selected and/or saved options. For example, upon selecting a frame such as the frame 524, the user may decide to deselect the selection of the frame 524, then the user may operate the ‘Undo’ option in the option display area 520.

In an embodiment, selection of various tabs, for example, the motion selection tab 542, the save tab 544, and the selection undo tab 546, may be facilitated by a user action. Also, as disclosed herein in various embodiments, various options being displayed in the options display area 540 are represented by tabs. It will however be understood that these options may be displayed or represented in various devices by various other means, such as push buttons, and user selectable arrangements.

In an embodiment, selection of the at least one object and various other option in the UI for example the UI 500 may be performed by, for example, a mouse-click, a touch screen user interface, detection of a gaze of a user and the like. In an embodiment, the plurality of frames may include a gesture recognition tab for recognizing a gesture being made by a user for selection of the frame. For example, as illustrated in FIG. 5A, the frame 524 and 530 includes gesture recognition tabs 552 and 554, respectively. The gesture recognition tabs may recognize the gesture made by the user, for example a thumbs-up gesture, a wow gesture, a thumbs-down gesture, and the like, and based on the recognized gesture may select or deselect the frame associated with the respective gesture recognition tab.

FIG. 5B illustrates an exemplary UI 600 for generating motion image associated with the multimedia content in an apparatus in accordance with another example embodiment. The UI 600 may be an example of a user interface 206 of the apparatus 200 or the UI 400 of FIG. 4. In the example embodiment as shown in FIG. 5B, the UI 600 is caused to display a scene area 610, a slide bar 620 for facilitating selection of the at least one frame, and an option display area 630. In an example embodiment, the scene area 610 displays a viewfinder of the image capturing and motion image generation application of the apparatus 200. In another embodiment, the screen area 610 may display a pre-recorded multimedia content of the apparatus 200.

As illustrated In FIG. 5B, the scene/video captured depicts a game of football between two teams. The match is assumed to be of a considerable duration, and the video of the match may be summarized. The slide bar 620 comprises a sequence of the plurality of frames associated with an event of the multimedia content. In an embodiment, the slide bar 620 may include sliders, for example sliders 622 and 624 for facilitating selection of at least one frame from the summarized multimedia content. In an embodiment, a user may select at least one frame from the plurality of frames by means of the sliders. The at least one frame may be a start frame that is indicative of a beginning of a mobile portion. In another embodiment, the user may select the start frame as well as an end frame from the plurality of the frames, as illustrated in FIG. 5B. Based on a user selection of the start frame and the end frame, a mobile portion for the motion image may be generated.

In an embodiment, the slide bar 620 may include a time of playing of one or more mobile portions associated with the motion picture. For example, a motion picture may include three mobile portion, and based on a user preference, the three motion pictures may be included in the motion image in a manner that each mobile portion may occur one after another in a sequence determined by the timeline appearing on the motion selection bar 620. In another embodiment, the sequence of the one or more mobile portions may be determined at least in parts or under certain circumstances automatically. For example, the sequence of various mobile portions may be determined to be same as that of their occurrence in the original multimedia content. In an embodiment, the time displayed on the slide bar 620 may be indicative of time duration of playing of one motion element.

In an embodiment, the option display area 630 facilitates in provisioning of various options for selection of the at least one frame in order to generate the motion image. In the option display area 630, a plurality of options may be displayed, for example a motion selection bar 632, a save tab 634, and a selection undo tab (shown as ‘undo’) 636. In an embodiment, the motion selection bar 632 facilitates in selection of a level of motion of the mobile portion of the motion image ranging from a slow motion to a fast motion. In an embodiment, the motion selection bar 632 may include a motion element, such as a motion element 638, for adjusting a level of speed of the selected motion element. In an embodiment, upon operating the motion element 638 on the motion selection bar 632, the speed of the mobile portion may be adjusted as per the user preferences.

In an embodiment, the selection of one or more options, such as operation of motion selection bar 632 for adjusting a speed of motion of the mobile portion may be saved. In an embodiment, the selection may be saved by operating the ‘Save’ tab 634 in the options display area 630. For example, upon operating the save tab 634, the mobile portion with the selected speed may be saved. In an embodiment, various selections such as that of the at least one frame, the speed of motion and the like may be reversed by operating the undo tab 636.

In an embodiment, selection of various options such as selection of the at least one frame on the motion selection bar 620 and various other options on the option display area 630 may be selected by means of a pointing device, such as a mouse, a joystick, and the like. In various other embodiments, the selection may be performed by utilizing a touch screen user interface, a user gesture, a user gaze and the like. Various examples of performing selection of options/frames for generating the motion image, are explained in detail in FIGS. 6A to 6D.

FIGS. 6A, 6B, 6C and 6D illustrate various embodiments for performing selection for generating motion images in accordance with various example embodiments. For example, FIG. 6A illustrates a UI 710 for selection of at least one frame and/or options by means of a mouse. As illustrated in FIG. 6A, a frame, for example a frame 712 is selected by a click of a, for example, a mouse 714. In alternative embodiments, the mouse 714 may be replaced by any other pointing device as well, for example, a joystick, and other similar devices. As illustrated the selection of the frames by the mouse may be presented to the user by means of a pointer for example an arrow pointer 716 on the user interface 710. In some embodiments, the mouse may be configured to select options and/or multiple objects as well on the user interface 710.

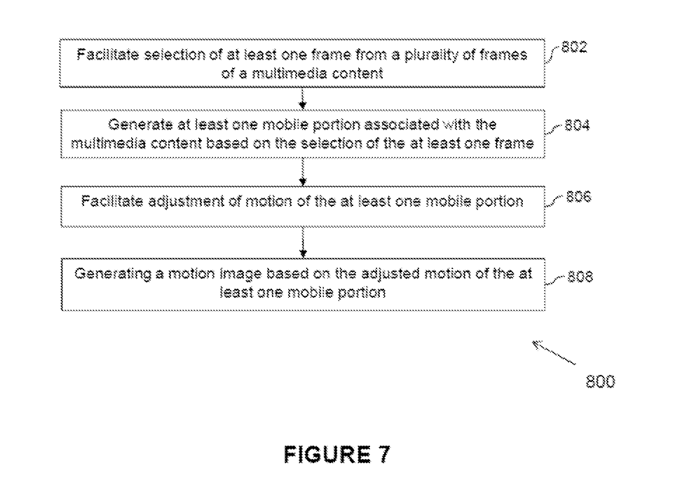

In another example embodiment, FIG. 7B illustrates a UI 720 enabling selection of the at least one frame and/or options by means of a touch screen interface associated with the UI 720. As illustrated in an example representation in FIG. 7B, at least one frame for example, the frame 722 may be selected by touching the at least object with a finger-tip (for example, a finger-tip 724) of a hand (for example, a hand 726) of a user displayed on a display screen of the UI 720.

In yet another embodiment, FIG. 7C illustrates a UI 730 for selection of the at least one frame and/or options by means of a gaze (represented as 732) of a user 734. For example, as illustrated in FIG. 7C, a user may gaze at at least one frame, for example a frame 735 displayed on a display screen of a UI for example, the UI 730. In an embodiment, based on the gaze 732 of the user 734, the frame 736 may be selected for being in motion in the motion image. In alternative embodiments, various other objects and/or options may be selected based on the gaze 732 of the user 734. In an embodiment, the apparatus, for example, the apparatus 200 may include sensors and other gaze detecting means for detecting the gaze or retina of the user for performing gaze based selection.

In still another embodiment, FIG. 6D illustrates a UI 740 for selection of at least one and/or options by means of a gesture (represented as 742) of a user. For example, in FIG. 6D, the user gesture 742 includes a ‘wow’ gesture made by utilizing a user's hand. In an embodiment, the UI 740 may recognize (represented by 744) the gesture made by the user, and retain or remove the user selection based on detected gesture. For example, upon detecting a ‘wow’ hand gesture (as shown in FIG. 7D) or a thumbs up gesture, the UI 740 may select a frame such as a frame 746, however, upon detecting a thumbs down gesture, the UI 740 may remove the selected frame. In an embodiment, the UI may detect the gestures by gesture recognition techniques.

FIG. 7 is a flowchart depicting an example method 800 for generating motion image associated with multimedia content, in accordance with an example embodiment. The method depicted in flow chart may be executed by, for example, the apparatus 200 of FIG. 2. In an embodiment, the multimedia content includes a video recording of an event, for example a match or a game, a birthday party, a marriage ceremony, and the like. In an embodiment, the motion image generated from the multimedia content may include a series of images encapsulated within an image file. The series of images may be displayed in a sequence, thereby creating an illusion of movement of objects in the motion image.

In an embodiment, the motion image comprises at least mobile portion (being generated from the series of images or corresponding frames) and a set of still portions. In an embodiment, the at least one mobile portion may comprise frames associated with key events of the multimedia content. For example, in a video recording of a birthday party, one of the mobile portion may be that of a cake-cutting event, another mobile portion may be that of a song sung during the event, and the like.

In an embodiment, for generating the motion image from the multimedia content, the multimedia content may be summarized to generate summarized multimedia content comprising a plurality of frames. In an embodiment, the summarization of the multimedia content is performed for generating key frames representative of key events associated with a multimedia content. In an embodiment, the summarization of the multimedia content may be performed while capturing the multimedia content. In an embodiment, the multimedia content may be captured by a multimedia capturing device, such as, the device 100. Examples of the multimedia capturing device may include, but are not limited to, a camera, a mobile phone having multimedia capturing functionalities, and the like. In an embodiment, the multimedia content may be captured by using 3-D cameras, 2-D cameras, and the like.

At 802, a selection of at least one frame of the plurality of frames of the multimedia content is facilitated. In an embodiment, the at least one frame comprises a starting frame of a mobile portion of the motion image. In some embodiment, the selection of the at least one frame is performed by a user. In some embodiments, the at least one frame includes an end frame of the mobile portion, such that the end frame of the mobile portion is also selected by the user. In alternate embodiments, the end frame is selected at least in parts and under certain circumstances automatically in the device, for example the device 100.

At 804, at least one mobile portion associated with the multimedia content is generated based on the selection of the at least one frame. For example, when the starting frame and the end frame of the at least mobile portion are selected, the mobile portion may be generated. At 806, an adjustment of motion of the at least one mobile portion is facilitated. In an embodiment, the adjustment of the motion of the at least one mobile portion comprises performing at least one of adjusting a level of speed of motion, a sequence of occurrence of the mobile portion, and a timeline indicative of occurrence of the at least one mobile portion in the motion image. In an embodiment, the speed of the motion of the mobile portion may vary from high to medium to a low speed. Various exemplary embodiments for facilitating the adjustment of speed of motion of the at least one mobile portion are explained with reference to FIG. 6A till 6D. In an embodiment, the speed of motion of the objects may be adjusted by utilizing a UI, for example, the UI 206. Various examples of the UI for adjusting the speed of the mobile portions are explained with reference to FIGS. 5A and 5B.

At 808, the motion image associated with the multimedia content is generated based on the adjusted motion of the mobile portion. In an embodiment, the generation of the motion image comprises generation of the set of still portions from the multimedia content, and combining the at least one mobile portions with the set of still portions for generating the motion image. In an embodiment, the motion image may be saved. In an embodiment, the motion image may be displayed by utilizing a user interface, for example, the UI 206. Various examples of the UI for performing various operations for generating the motion image and displaying the motion image are explained with reference to FIGS. 5A and 5B.

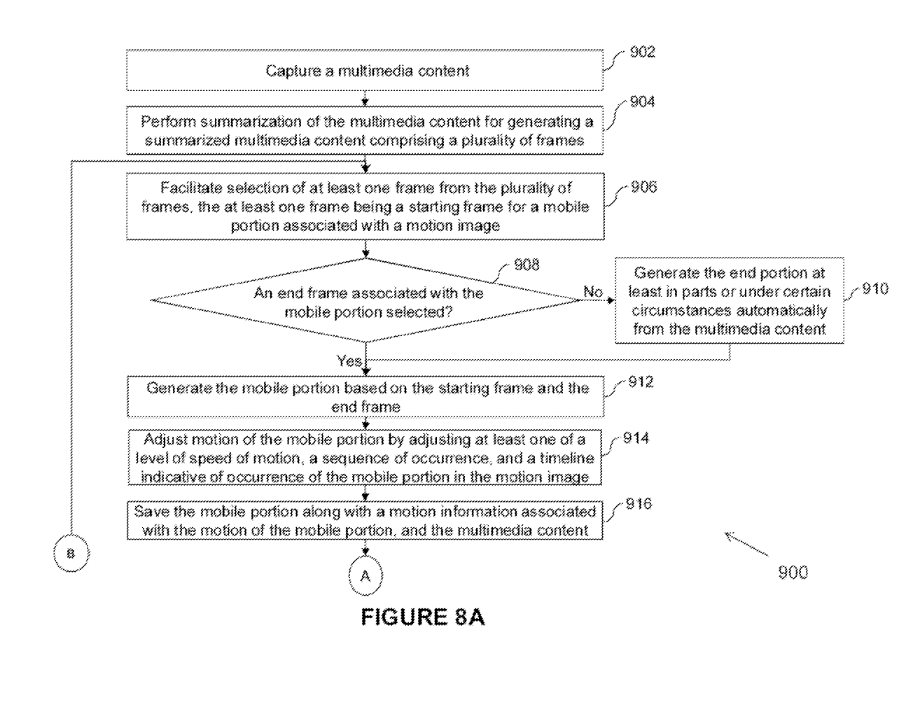

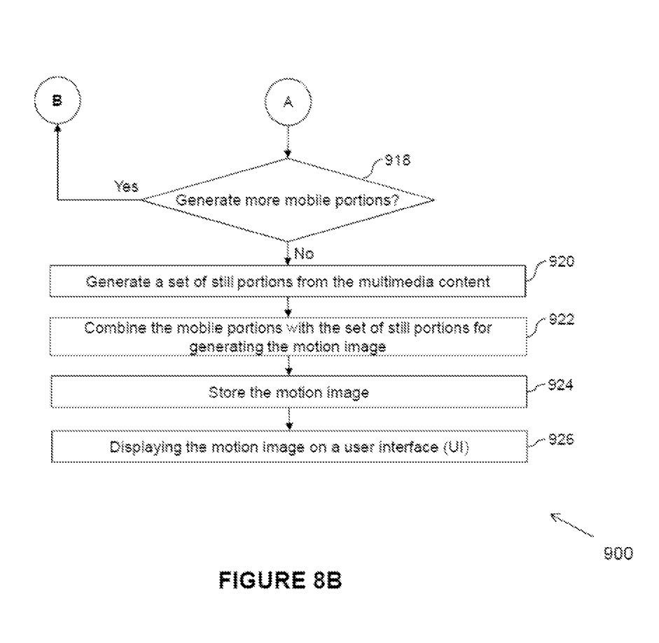

FIGS. 8A and 8B are a flowchart depicting an example method 900 for generation of motion image associated with a multimedia content, in accordance with another example embodiment. The method 900 depicted in flow chart may be executed by, for example, the apparatus 200 of FIG. 2. Operations of the flowchart, and combinations of operation in the flowchart, may be implemented by various means, such as hardware, firmware, processor, circuitry and/or other device associated with execution of software including one or more computer program instructions. For example, one or more of the procedures described in various embodiments may be embodied by computer program instructions. In an example embodiment, the computer program instructions, which embody the procedures, described in various embodiments may be stored by at least one memory device of an apparatus and executed by at least one processor in the apparatus. Any such computer program instructions may be loaded onto a computer or other programmable apparatus (for example, hardware) to produce a machine, such that the resulting computer or other programmable apparatus embody means for implementing the operations specified in the flowchart. These computer program instructions may also be stored in a computer-readable storage memory (as opposed to a transmission medium such as a carrier wave or electromagnetic signal) that may direct a computer or other programmable apparatus to function in a particular manner, such that the instructions stored in the computer-readable memory produce an article of manufacture the execution of which implements the operations specified in the flowchart. The computer program instructions may also be loaded onto a computer or other programmable apparatus to cause a series of operations to be performed on the computer or other programmable apparatus to produce a computer-implemented process such that the instructions, which execute on the computer or other programmable apparatus provide operations for implementing the operations in the flowchart. The operations of the method 900 are described with help of apparatus 200. However, the operations of the method can be described and/or practiced by using any other apparatus.

At block 902, a multimedia content may be captured. In an embodiment, the multimedia content may be a video recording of an event. Examples of the multimedia content may include a video presentation of a television program, a birthday party, a religious ceremony, and the like. In an embodiment, the multimedia content may be captured by a multimedia capturing device, such as, the device 100. Examples of the multimedia capturing device may include, but are not limited to, a camera, a mobile phone having multimedia capturing functionalities, and the like. In an embodiment, the multimedia content may be captured by using 3-D cameras, 2-D cameras, and the like.

At block 904, summarization of the multimedia content is performed for generating summarized multimedia content. In an embodiment, the summarization may be performed while capturing the multimedia content. In another embodiment, the summarization may be performed after the multimedia content is captured. For example, the multimedia content stored in a device, for example, the device 100 may be summarized. In an embodiment, the summarized multimedia content comprises a plurality of frames representative of key shots of the multimedia content. In an embodiment, the plurality of frames may be displayed on a UI, for example the UI 206. Various other examples of the UI for displaying the plurality of frames are explained in detail in FIGS. 5A and 5B. In an embodiment, the plurality of frames may be displayed on the UI in a sequence of appearance thereof in the original captured multimedia content.

In an embodiment, for generation of motion image, at least one mobile portion and a set of still portions associated with the motion image are generated from the summarized multimedia content. At 906, a selection of at least one frame from the plurality of frames is facilitated. In an embodiment, the at least one frame is a starting frame of the mobile portion of the motion image. For example, for a mobile portion associated with a cake cutting event in a birthday party, the starting frame may comprise a frame showing a user lifting a knife for cutting the cake. Various other examples and embodiments for selection of the starting frame of mobile portion are possible. In an embodiment, the selection of the starting frame is facilitated by a user by means of a user action on a UI. In an embodiment, the starting frame selected by the user may be shown in a distinct color, for example, red color on the UI.

At 908, it is determined whether an end frame of the mobile portion is selected. In an embodiment, the end frame may be a last frame of mobile portion. For example, for a mobile portion associated with a cake cutting event, the end frame may comprise of the user offering a piece of the cake to another person. In an embodiment, if it is determined at 908 that the end frame of the mobile portion is not selected, then at 910, a frame associated with the end portion is selected at least in parts and under certain circumstances automatically. In an example embodiment, the end frame may be a frame subsequent to which, a substantial change of a scene is detected.

If it is determined at 908 that the end frame of the mobile portion is selected, for example by the user, then at 912, a mobile portion is generated based on the starting frame and the end frame. In an embodiment, the starting frame and the end frame of the mobile portion may be shown highlighted in a distinct color for enabling the user to identify the mobile portion. In an embodiment, the user may deselect either one or both of the starting frame and the end frame, and in its place, select a new frame for generating the mobile portion.

At 914, a motion of the mobile portion is adjusted. In an embodiment, adjusting the motion of the mobile portion comprises performing at least one of adjusting a level of speed of motion, a sequence of occurrence of the mobile portion, and a timeline indicative of occurrence of the at least one mobile portion in the motion image. In an embodiment, the speed of the motion of the mobile portion may vary from high to medium to a low speed. Various exemplary embodiments for facilitating the adjustment of speed of motion of the at least one mobile portion are explained with reference to FIGS. 5A and 5B.

In an embodiment, the speed of motion of the objects may be adjusted by utilizing a UI, for example, the UI 206. Various examples of the UI for adjusting the speed of the mobile portions are explained with reference to FIGS. 5A and 5B. In an embodiment, the sequence of the occurrence of the mobile portions may be adjusted by the user. In alternative embodiments, the sequence of the occurrence of the mobile portions may be adjusted at least in parts and under certain circumstances automatically. For example, the sequence of various mobile portions may be adjusted based on the sequence of occurrence of the respective mobile portions in the original multimedia content.

At 916, the mobile portion along with a motion information associated with the motion of the mobile portion, is saved along with the multimedia content. In an embodiment, the motion information of the mobile portion, for example, the selected speed of the mobile portion and the mobile portion may be saved in a memory, for example, the memory 204. At 918, it is determined whether or not more mobile portions are to be generated. If at 918, it is determined that additional mobile portions are to be generated, the additional mobile portions may be generated following from 906 till 916, until it is determined at 918 that no more mobile portions are to be generated.

If it is determined at 918 that no more mobile portions are to be generated, then at 920 a set of still portions may be generated from the multimedia content. In an embodiment, the set of still portions may be generated by selecting iframes and the representative frames at least in parts or under certain circumstances automatically from the multimedia content. In various embodiments, two similar looking frames may not be selected for configuring the still portions of the motion image. For example, the adjacent frames having a minimal motion change may not be selected as the still portions of the motion image. In various embodiments, the still portions may be selected while capturing the multimedia content. For example, during the multimedia capture, the frames for generating the still portions (herein after referred to as still frames) may be selected at least in parts or under certain circumstances automatically depending on one or more of the resolution, bandwidth, quality, and screen size of the motion image. For example, in case a low-resolution motion image is desired, the captured frames may be inserted in-between the various frames of the mobile portion at regular intervals. As another example, in case a high-resolution motion image is desired, then all the still portions may be high resolution image frames, for example, 8 megapixel frame, thereby enabling better zooming in the motion image.

At 922, the mobile portions and the set of still portions may be combined together for generating the motion image. In an embodiment, the audio portions associated with the multimedia content may be replaced with separate audio content, that may synchronize with the mobile portion being played in the motion image. For example, for a birthday party event, an original audio content associated with the cake cutting event may be replaced with a birthday song sung by a famous singer. Replacement of the original audio content with other audio content has the advantage of proving better user experience.

In an embodiment, the motion image generated at 922 may be stored at 924. In an embodiment, the motion image may be stored in a memory, for example, the memory 204. In an embodiment, the generated motion image may be displayed at 926. In an embodiment, the motion image may be displayed by utilizing a user interface, for example, the UI 206. Various exemplary embodiments of UIs for displaying the generated image are illustrated and explained with reference to FIGS. 5A and 5B.

In an example embodiment, a processing means may be configured to perform some or all of: facilitating selection of at least one frame of a plurality of frames of a multimedia content; generating at least one mobile portion associated with the multimedia content based on the selection of the at least one frame; facilitating adjustment of motion of the at least one mobile portion; and generating a motion image based on the adjusted motion of the at least one mobile portion. An example of the processing means may include the processor 202, which may be an example of the controller 108.

To facilitate discussion of the method 900 of FIGS. 8A and 8B, certain operations are described herein as constituting distinct steps performed in a certain order. Such implementations are exemplary and non-limiting. Certain operation may be grouped together and performed in a single operation, and certain operations can be performed in an order that differs from the order employed in the examples set forth herein.

Moreover, certain operations of the method 900 are performed in an automated fashion. These operations involve substantially no interaction with the user. Other operations of the method 900 may be performed by in a manual fashion or semi-automatic fashion. These operations involve interaction with the user via one or more user interface presentations (as described in FIGS. 6A till 6D).

In an embodiment, the method for generating motion image from the multimedia content may be utilized for various applications. In an exemplary application, the method may be utilized for generating targeted advertisements for customers. For example, a multimedia content, for example a video recording may comprise of a plurality of objects of which a user may be interested in one object. Based on a preference or interest, the user may select at least one frame comprising the object of user's interest. In an embodiment, the selection of at least one frame may comprise tagging the object on the at least one frame. In an embodiment, the selection of the at least one frame being made by the user may be stored. In an embodiment, the selection may be stored in database, a server, and the like. In an embodiment, based on the selected at one frame, various other stored objects may be searched for the tagged object in a database. For example, a video may be captured at a house, such that the video covers all the rooms and the furniture. The captured video may be utilized for an advertisement for sale of the furniture kept in the house. The video may be summarized to generate summarized video content comprising a plurality of key frames of the video, and may be shared on a sever. Whenever a potential customer accesses this video, he/she may select the at least one frame comprising the tagged furniture as a user frame of interest (or UFOI). The UFOI selected by the user may be stored in server and/or a database in a device, such as the device 100. An object recognition may be performed on the UFOI and objects similar to those in the UFOI (such as the selected furniture) may be retrieved from the database/server. The retrieved objects and/or advertisements of the objects may be shown or made available dynamically to the user.

Without in any way limiting the scope, interpretation, or application of the claims appearing below, a technical effect of one or more of the example embodiments disclosed herein is to facilitate generation of motion image from the multimedia content. The motion image is generated by generating at least one mobile portion and a set of still portions from the multimedia content, and combining the same. In an embodiment, various mobile portions may be generated and a motion thereof may be adjusted by means of a user interface. For example, the mobile portions may be touched on the UI and a speed of motion thereof may be adjusted. The mobile portions with the adjusted speeds may be stored in the motion image. In various other embodiments, the UI for generating and displaying the motion image may include a timeline that may facilitate in placing various mobile portions in a sequence, and the mobile portions may be played in the motion image based on the sequence of placement thereof on the timeline. In an alternative embodiment, not all the mobile portions of the motion image may be rendered in motion. Instead, only upon being touched, for example by a user on the UI, the respective mobile portion is rendered in motion. The methods disclosed herein facilitates in retaining the liveliness of the multimedia content, for example the videos while capturing the most interesting details of the video in an image, for example a JPEG image. Moreover, the method allows to generate the motion images automatically while capturing the multimedia content, thereby precluding a need to open any other application for motion image generation.

The motion image generated by the methods and systems disclosed herein allows easy sharing most beautiful scenes quickly and convenient without a large memory requirement. The method provides a novel and a playful experience with the imaging technology without a need of any additional and complex editing tools for making the motion images.

Various embodiments described above may be implemented in software, hardware, application logic or a combination of software, hardware and application logic. The software, application logic and/or hardware may reside on at least one memory, at least one processor, an apparatus or, a computer program product. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of an apparatus described and depicted in FIGS. 1 and/or 2. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present disclosure as defined in the appended claims.

1-45. (canceled)

46. A method comprising:
facilitating selection of at least one frame from a plurality of frames of a multimedia content;
generating at least one mobile portion associated with the multimedia content based on the selection of the at least one frame;
facilitating adjustment of motion of the at least one mobile portion; and
generating a motion image based on the adjusted motion of the at least one mobile portion.

47. The method as claimed in claim 46 further comprising performing summarization of the multimedia content for generating the plurality of frames.

48. The method as claimed in claim 46, wherein the at least one frame comprises a starting frame of the mobile portion of the motion image.

49. The method as claimed in claim 46 further comprising facilitating selection of an end frame associated with the at least one mobile portion of the motion image.

50. The method as claimed in claim 46 further comprising generating a set of still portions associated with the multimedia content.

51. The method as claimed in claim 50 further comprising combining the set of still portions with the at least one mobile portion for generating the motion image.

52. The method as claimed in claim 46, wherein adjusting the motion of the at least one mobile portion comprises performing at least one of adjusting a level of speed of motion, a sequence of occurrence of the least one mobile portion, and a timeline indicative of occurrence of the at least one mobile portion in the motion image.

53. An apparatus comprising:
at least one processor; and
at least one memory comprising computer program code, the at least one memory and the computer program code configured to, with the at least one processor, cause the apparatus to at least perform:
facilitate selection of at least one frame from a plurality of frames of a multimedia content;
generate at least one mobile portion associated with the multimedia content based on the selection of the at least one frame;
facilitate adjustment of motion of the at least one mobile portion; and
generate a motion image based on the adjusted motion of the at least one mobile portion.

54. The apparatus as claimed in claim 53, wherein the apparatus is further caused, at least in part, to: perform summarization of the multimedia content for generating the plurality of frames.

55. The apparatus as claimed in claim 53, wherein the at least one frame comprises a starting frame of the mobile portion of the motion image.

56. The apparatus as claimed in claim 53, wherein the apparatus is further caused, at least in part, to: facilitate selection of an end frame associated with the at least one mobile portion of the motion image.

57. The apparatus as claimed in claim 53, wherein the apparatus is further caused, at least in part, to: generate a set of still portions associated with the multimedia content.

58. The apparatus as claimed in claim 57, wherein the apparatus is further caused, at least in part, to: combine the set of still portions with the at least one mobile portion for generating the motion image.

59. The apparatus as claimed in claim 53, wherein the apparatus is further caused, at least in part, to: adjust the motion of the at least one mobile portion by performing at least one of adjusting a level of speed of motion, a sequence of occurrence of the at least one mobile portion, and a timeline indicative of occurrence of the at least one mobile portion in the motion image.

60. A computer program product comprising at least one computer-readable storage medium, the computer-readable storage medium comprising a set of instructions, which, when executed by one or more processors, cause an apparatus at least to perform:
facilitate selection of at least one frame from a plurality of frames of a multimedia content;
generate at least one mobile portion associated with the multimedia content based on the selection of the at least one frame;
facilitate adjustment of motion of the at least one mobile portion; and
generate a motion image based on the adjusted motion of the at least one mobile portion.

61. The computer program product as claimed in claim 60, wherein the apparatus is further caused, at least in part, to: perform summarization of the multimedia content for generating the plurality of frames.

62. The computer program product as claimed in claim 60, wherein the at least one frame comprises a starting frame of the mobile portion of the motion image.

63. The computer program product as claimed in claim 60, wherein the apparatus is further caused, at least in part, to: facilitate selection of an end frame associated with the at least one mobile portion of the motion image.

64. The computer program product as claimed in claim 60, wherein the apparatus is further caused, at least in part, to: generate a set of still portions associated with the multimedia content.

65. The computer program product as claimed in claim 64, wherein the apparatus is further caused, at least in part, to: combine the set of still portions with the at least one mobile portion for generating the motion image.

66. The computer program product as claimed in claim 60, wherein the apparatus is further caused, at least in part, to: adjust the motion of the at least one mobile portion by performing at least one of adjusting a level of speed of motion, a sequence of occurrence of the at least one mobile portion, and a timeline indicative of occurrence of the at least one mobile portion in the motion image.
